(19) United States
(12) Patent Application Publication
(10) Pub. No.: US 2017/0284655 A1
(43) Pub. Date: Oct. 5, 2017

(54) Free Standing Seamless Led Corner Display Facade

(71) Applicant: Corey Shane Rasmussen, Tucson, AZ (US)

(72) Inventor: Corey Shane Rasmussen, Tucson, AZ (US)

(21) Appl. No.: 15/086,980

(22) Filed: Mar. 31, 2016

(51) Int. Cl. F21V 33/00; F21V 23/06

(52) U.S. Cl. CPC F21V 33/0012; F21V 23/06; F21Y 2115/10

(57) ABSTRACT

The present invention allows for platform use with seamless corners, Smooth trimmed top and sides, built in power outlets with USB outlets as well. The screen is elevation off the floor. The Led Display façade is made of Aluminum which we call a cabinet or frame that simulates a small “U” shape when viewing from a top view perspective that was specially designed to sit on the floor allowing the cabinets screen to sit elevated two inches and protruded two inches forward. It raises the Led modules (also called Led Screen) off the ground to avoid any damage to the Led modules. The back of the cabinet has built in power & USB sockets to power external equipment. The display stands 4 feet high and has seamless corners for perfected viewing. It consists of 3 separate sections and breaks down for easy mobility and storage.

### BACKGROUND OF THE INVENTION

The present invention relates to Led displays also called led screens or cabinets.

Regular Led Displays are restricted for either wall mounting or laid on the floor. Regular displays do not have built in power outlets for powering external equipment (e.g., CD player, Turn table, Laptop computer.).

Regular Led Displays are not built to sit flat on the ground so the modules (e.g., Led module, screen) would get damaged and water could easily short circuit them.

Regular Led Displays do not have standing seamless corner panels. Conventional displays are only 1000 mm is height.

### BRIEF SUMMARY OF THE INVENTION

The present invention allows for platform use with seamless corners, Smooth trimmed top and sides, built in power and screen elevation off the floor. Disclosed herein is an apparatus that is made of Aluminum or iron which we call a cabinet or frame that simulates a small “U” shape when viewing from a top view perspective that was specially designed to sit on the floor allowing the cabinets screen to sit elevated and protruded forward. It raises the Led modules (also called Led Screen) 2 inches off the ground to avoid any damage to the modules. The back of the cabinet has built in power & USB sockets to power external equipment. The display stands 4 feet high and has seamless corners for perfected viewing. It consists of 3 separate sections and breaks down for easy mobility and storage.

### BRIEF DESCRIPTION OF THE SEVERAL VIEWS OF THE DRAWINGS

FIG. 1 is a back perspective view of the invention angled from the bottom tilted back illustrating the general configuration of components and placement of our corner display façade. FIG. 1b is an orthographic view of the back of the invention. FIG. 1c is another perspective view of the invention angled from the top and tilted forward. FIG. 1d is the same as FIG. 1b but showing a detailed view of one of the used components. FIG. 2 is an elevation view of the invention. FIG. 3 is a right orthographic view of the invention. FIG. 4 is a left orthographic view of the invention. FIG. 5 is the top orthographic view of the invention. FIG. 6 is the bottom orthographic view of the invention. FIG. 7 is a top right detail view of the invention showing the seamless led corner. FIG. 7b is a detailed perspective view of the left side of the invention showing the seamless led corner.

### DETAILED DESCRIPTION OF THE INVENTION

I would like to explain what's so unique about this invention I call the “Standing seamless led corner display façade”. There are many types of Led displays & Screens on the market. There are also led dance Floors. These products are your standard basic cabinets with four interlocking sides to build your wall or dance floor. They have nothing for free standing façades or booths. The Led Panels seen similar are just some standard cabinets arranged, stacked or lined together using existing led cabinets which were meant for walls. They have no trim, rough edges and sit on the floor. Their use was never intended for the floor till now. My standing seamless led corner display façade is much more than just some panels stacked or lined together. We custom designed each panel which are taller than any panel on the market and made it so there is only one direction to connect together. We have unique corner pieces we designed which have seamless corners so the led wraps right around the corner with no gap. The panels allow for the Led modules to be elevated two inches off the floor to avoid damage and for better exposure. There is a smooth trim over the top and sides of our façade for that clean professional look. We have built in power outlets for both 110V-220V and USB 2.4A sockets. We believe we are the first to use built in power in these cabinets to power external equipment (e.g., mixer, cd player, laptop) No other cabinets would have these features since they were never made for the ground to free stand. We offer a highly mobile and unique standing led façade. Detail description follows.

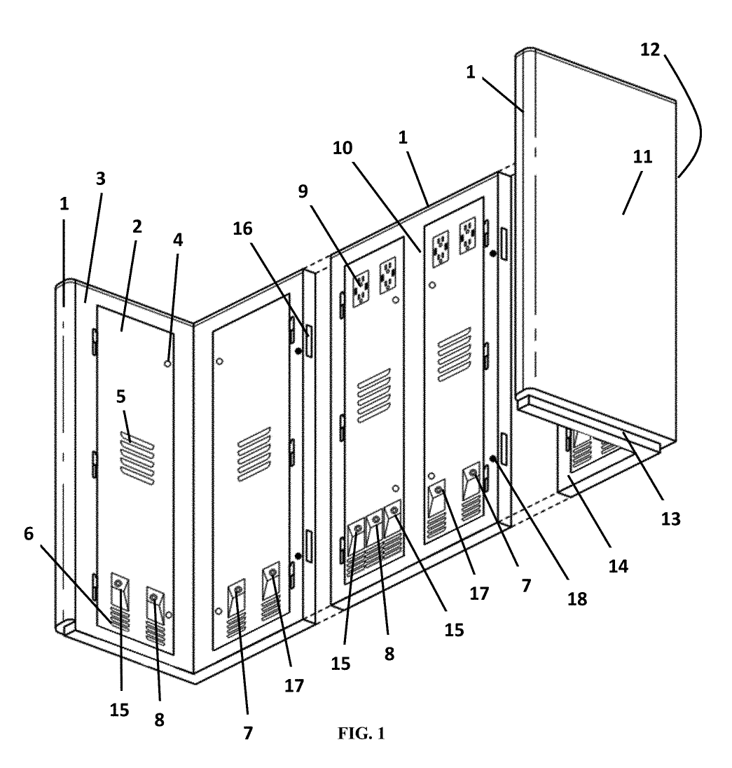

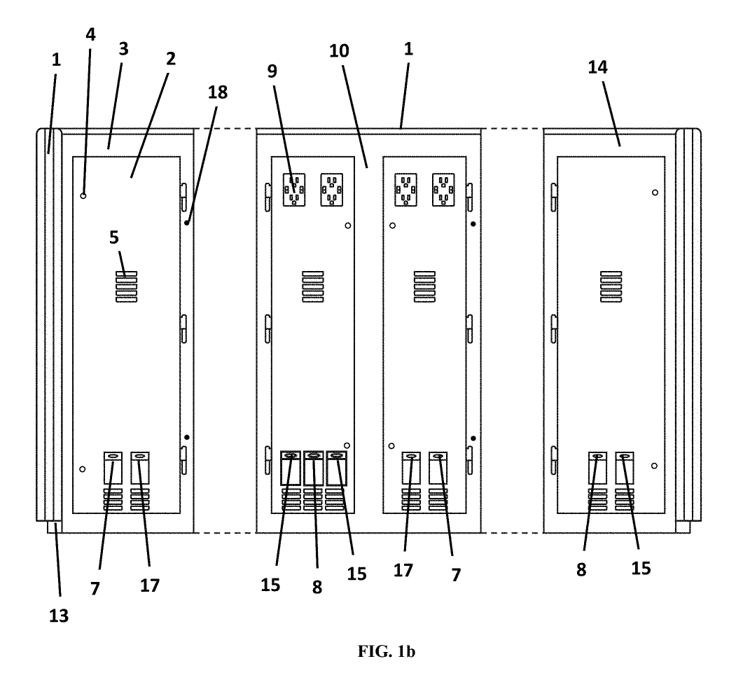

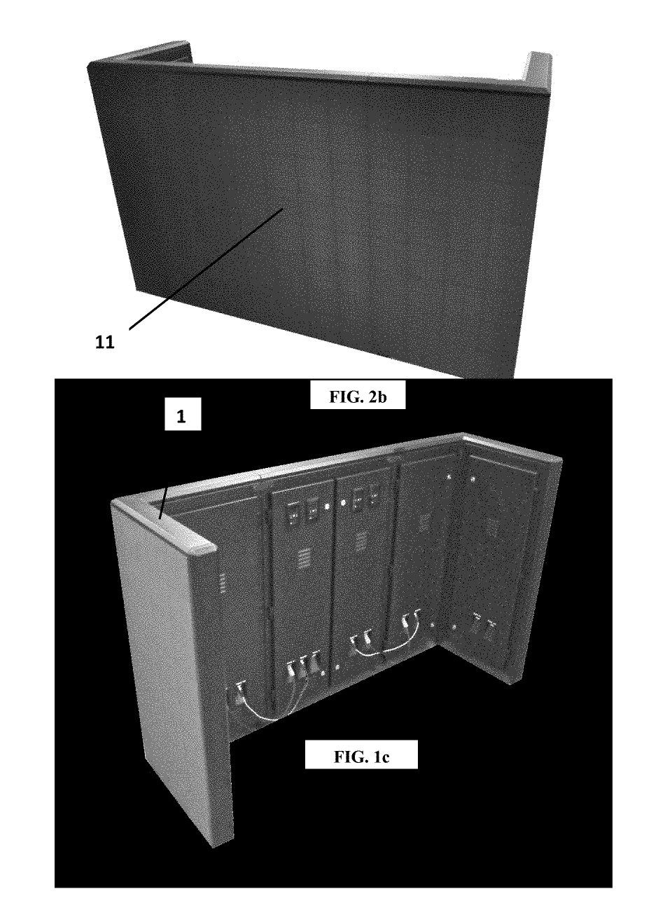

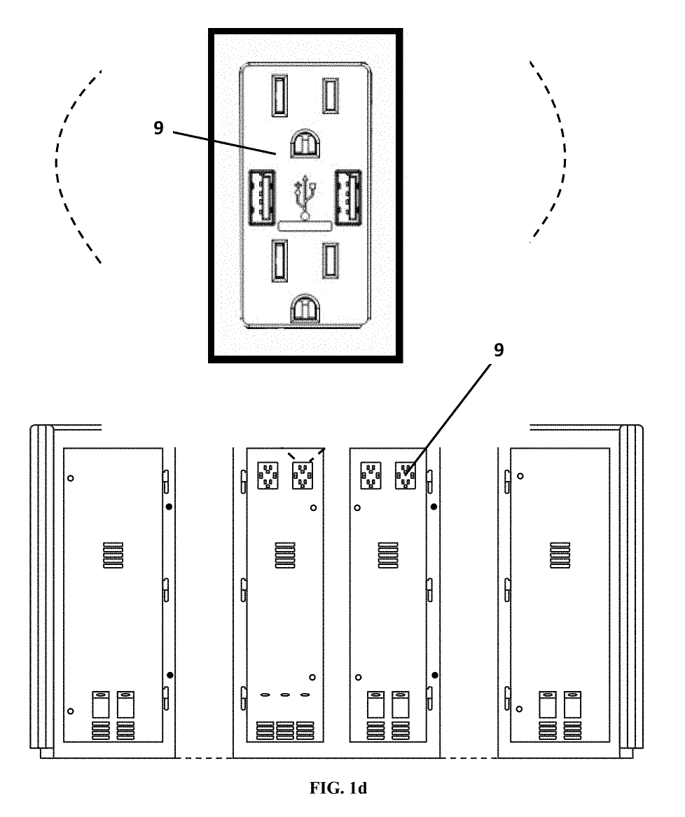

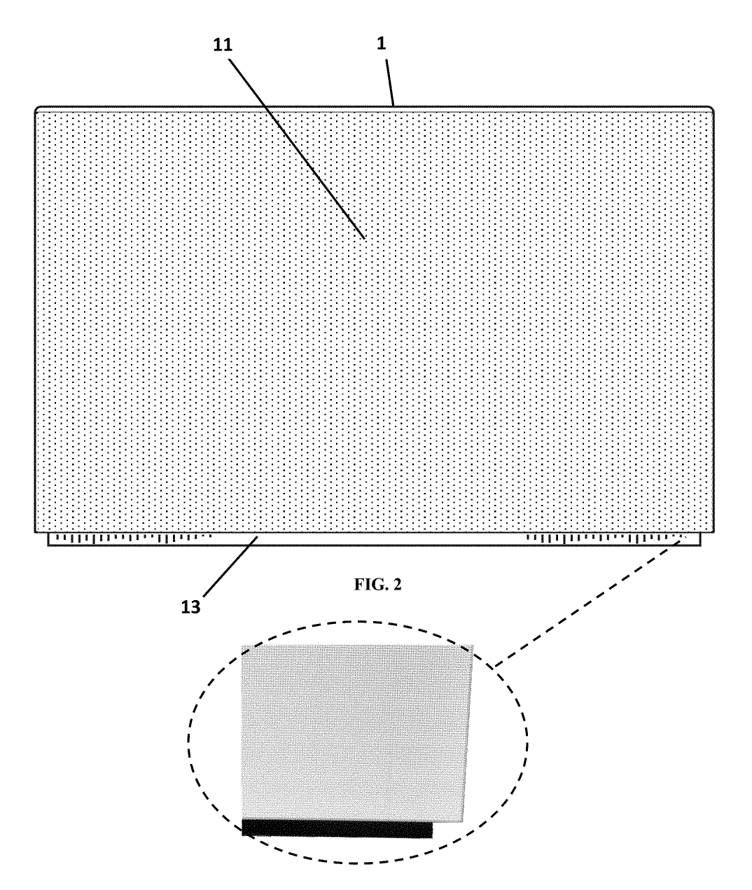

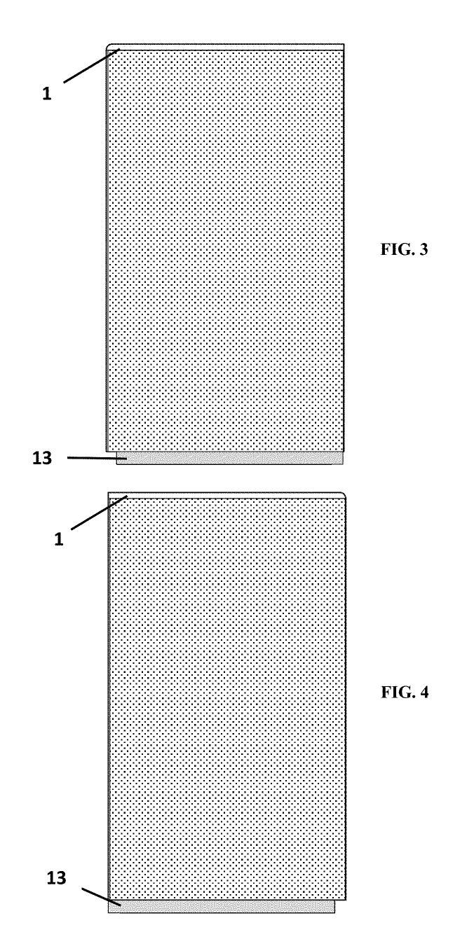

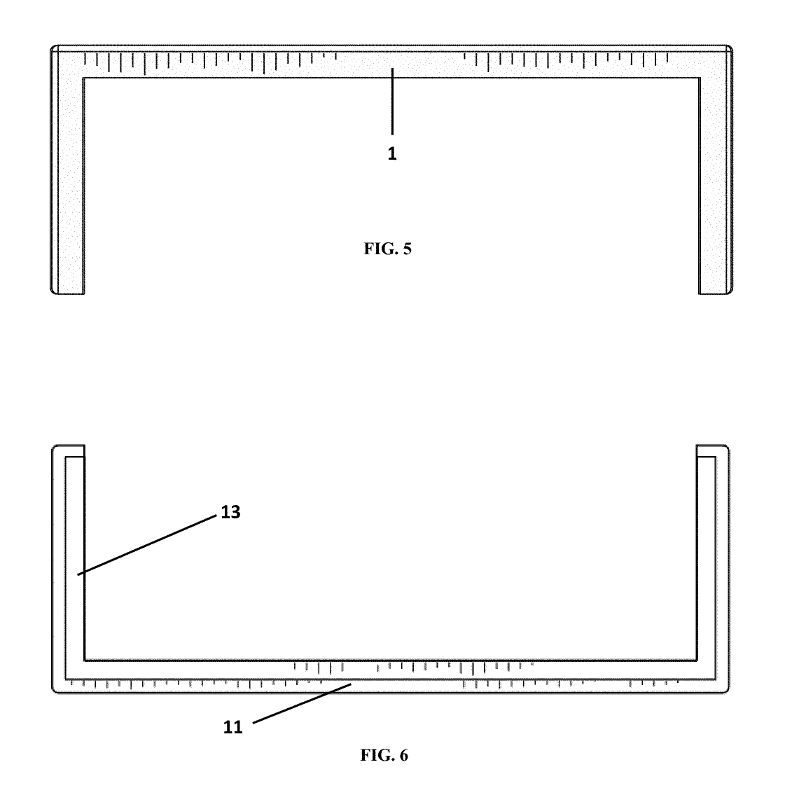

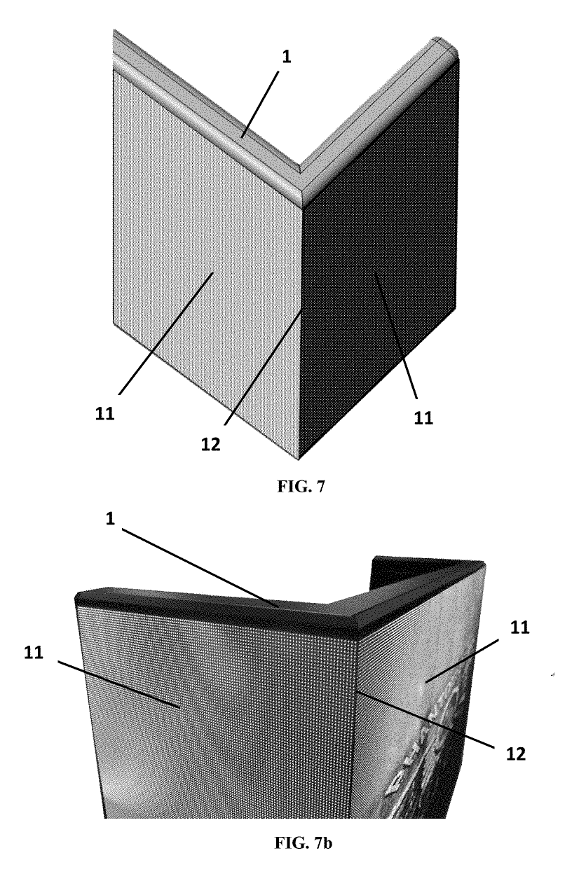

Referring to FIG. 1 this invention as a completed product is made up of three unique individual panels 3,10,14 which hold the led modules 11 which interlock together making one complete product. These panels 3, 10, 14 were specifically built to stand on the ground to create a façade, a booth to utilize as a DJ's workstation, tradeshow promotions stand, for events and parties. These panels 3,10, 14 are 1280 mm high altogether with custom raised base support 13 to elevate these panels two inches off the ground. This ensures the safety of the led modules 11 from getting damaged by concrete, carpet and any liquids or flooding that may occur.

Also shown in FIG. 1, 1b, 1c, FIG. 5, FIG. 7, 7b there is a beveled smooth aluminum trim 1 covering both the top and the sides of the invention 3, 10, 14 to give it a smooth and elegant look. This trim 1 is permanently mounted on each of the panels 3, 10, 14. The two corner panels 3, 14 have side trim 1 as well going down its sides. FIG. 7, 7b shows you a detail perspective view of the trim.

In FIG. 1, 1b each of the panels 3, 10, 14 have cabinet doors 2 housing the panel's electrical components to operate the led modules 11. These doors have key locks 4 to eliminate tampering. The cabinet doors 2 also have built in vents 5 for heat dissipation with lower vents 6 for added airflow. Each panel 3,10,14 has a built in latch 16 so when pressing the panels together you turn the Allen key one twist clockwise in slot 18 to lock the panels together.

Referring to FIG. 1, 1b, 1c, 1d we have installed four special power outlets with USB ports 9 which is used to power external equipment such as (e.g., Dj equipment, laptop, Mixer) in panel 10. See FIG. 1d for detailed outlet view. These outlets 9 are powered by adding a Neutrik input power cables to connectors 15 by plugging and twisting to lock the cable in. This powers both the outlets and the panels 3, 10, 14. There are also Neutral input and output daisy chain connectors 8,7,17 to power all the panels 3, 10, 14. No other led cabinet floor or wall has built in sockets to power external equipment.

As seen in FIG. 1, FIG. 2, 2b, FIG. 3, FIG. 4 These are Led modules which make up our led screen 11. These modules are built precise and flush under the smooth beveled trim 1 and elevated two inches off the ground 13. FIG. 7, 7b refers and shows the seamless led modules 11 tightly together. These modules 11 wrap forty-five degrees around and go two feet back allowing for the panels led booths main support 3, 14. There are led billboards which show Leds making a 45 degree corner but these are built into place and cannot be removed. Our panels 3, 14 are custom designed to be mobile and don't damaged easily. They are the only seamless led panels which are made for floor standing. Our Screen 11 allows for a 16:9 aspect ratio and 416 p×256 p resolution for playing videos & photos and 672×256 p resolution full screen when playing abstracts and effects.

Referring to FIG. 1, FIG. 2, FIG. 3, FIG. 4, FIG. 6 these are the views of the raised part 13 of the panels 3, 10, 14. This raised part 13 is two inches higher and deeper than the modules 11. This allows for the led modules to be elevated from the ground two inches as well as stick out in front two inches. See FIG. 3, FIG. 4 for a better view and understanding of the base 13. FIG. 6 is the bottom view showing the base 13 and led modules 11 so you can see how they are protruding forward as well.

1. Standard Led cabinets are only for wall or laid flat as a dance floor and come in square sizes. Characterized in that, our 1280 mm free-standing sectional led floor façade with raised led screen with custom high cabinets built exclusively for hotel & hospitality, reception, DJ Façade, media entertainment and mobility. (FIG. 1)

2. Standard Led cabinets are flat and installed custom by hanging on a truss or mounted on a wall as a billboard. Characterized in that ours is a free-standing seamless led corner panel façade assembly with a 45 degree angled screen. (FIG. 7, 7b)

3. Regular led cabinets are made to have all four sides put together leaving no smooth surface. Characterized in that my free-standing led panels have custom smooth aluminum trimmed beveled top and side surfaces. (FIG. 1, 1c, FIG. 7, 7b)

4. Standard Led cabinets have no outlet sockets built in for powering any devices since they are made for hanging or laid flat as a dance floor. Characterizing that I claim to have the first built in power outlets with sockets and USB inputs in the back of the led panels to power external equipment. (FIG. 1b, FIG. 1d)

5. Our free standing Led floor Façade is made of 3 sections that are assembled in a very short period of time by interlocking them together. Two sections are custom 45 degree seamless corner panels.

6. Our free standing Led floor Façade was specially designed to sit on the floor allowing the cabinets screen to sit elevated and protruded forward. It raises the Led modules two inches off the ground to avoid any damage to the modules. (FIG. 3, 4)
